(19) United States
(12) Patent Application Publication
(10) Pub. No.: US 2021/0379906 A1
(43) Pub. Date: Dec. 9, 2021

(54) PERSONALIZED AUTOMATIC CUSTOMIZATION METHOD AND APPARATUS FOR A RING-PULL CAN

(71) Applicant: Shanxi Tongchuang Laser Advanced Manufacturing Co., Ltd., Taiyuan City (CN)

(72) Inventors: Tianzhe WEN, Taiyuan (CN); Changsheng XIE, Taiyuan (CN); Qiang MA, Taiyuan (CN)

(73) Assignee: Shanxi Tongchuang Laser Advanced Manufacturing Co., Ltd., Taiyuan City (CN)

(21) Appl. No.: 17/221,502

(22) Filed: Apr. 2, 2021

(30) Foreign Application Priority Data
Jun. 9, 2020 (CN) 202010519572.6

(51) Int. Cl. B41J 3/407; B41J 2/46; B41J 2/455

(52) U.S. Cl. CPC B41J 3/40733; B41J 3/40731; B41J 2/455; B41J 2/46

(57) ABSTRACT

Provided are a personalized automatic customization method and an apparatus for a ring-pull can. In the apparatus, a bin device is located at an upper part of the apparatus, a distributing device is installed below a bin device, and a pushing device is arranged on a side of the distributing device and a positioning device. A pattern of a marking content is set on the control system, and a feeding wheel is driven to rotate so that a canned beverage falls down. The pushing device pushes the ring-pull can to the positioning device. The control system receives the positioning signal, and a marking header of the marking device is driven to mark on an outer surface of the ring-pull can. The pushing device pushes the ring-pull can towards a second chute, and an electrical thrust cylinder extends the push rod out thereof to push the discharging hopper forward.

### CROSS REFERENCE TO RELATED APPLICATION

This application claims the priority of Chinese Patent Application No.202010519572.6, filed with the Chinese Patent Office on Jun. 9, 2020, which is incorporated herein by reference in its entirety.

### TECHNICAL FIELD

The present disclosure relates to a customized printing device, and in particular, to a personalized automatic customization method and an apparatus for a ring-pull can.

### BACKGROUND ART

Currently, the appearance of a ring-pull can for beverage on the market is mostly set by a manufacturer and are divided into different graphic solutions at most according to a sales requirement. However, with the improvement of the living condition of people, particularly the pursuit of the young consuming community is more and more personalized, only mass production has failed to meet the needs of individualized expression of people.

### SUMMARY

In view of the above case, a technical solution provided by the present disclosure provides a personalized automatic customization device and method for a canned beverage, which can meet the increasing needs for a personalized customization of people, and also avoid the high consumption brought by specialized customization.

In order to achieve the above object, the technical solution adopted by the present disclosure is to provide a personalized automatic customization method and an apparatus for a ring-pull can. The personalized automatic customization apparatus for the ring-pull may specifically comprises: a bin device, a distributing device, a pushing device, a positioning device and a discharging device. The bin device is located at an upper part of the apparatus, the distributing device is installed below the bin device, and the pushing device is arranged on a side of the distributing device and the positioning device.

In the bin device, a bin employs a V-shaped structure. An upper portion of the bin is free of lid, a lower portion of the bin is provided with a outfeed opening, a side door of the bin can be opened, and the side door is provided with an elongated hole. The ring-pull can be placed in the bin only in a single row.

The distributing device is mounted below the outfeed opening, a feeding wheel is machined with a nylon block, and four semicircular feeding grooves are arranged at equal intervals around an axial direction of the feeding wheel, and the feeding wheel is driven by a motor to rotate. A first chute is mounted below the feeding wheel, and the first chute is connected to a U-shaped groove arranged below the first chute.

The pushing device comprises a linear actuator and a pushing bar. The pushing bar can be driven by the linear actuator to push the ring-pull can to a marking position and a discharging position.

The positioning device employs a roller type rotation mechanism. The positioning device particularly comprises two rollers, a motor is mounted below the rollers, the motor drives the rollers via a belt to rotate, and positioning sensors is mounted above a first side of each of the rollers.

The pushing device is located on a common side of the U-shaped groove and the positioning device, the pushing device is an electric linear actuator, the pushing bar is mounted on a sliding block of the linear actuator , and a tail end of the pushing bar is of a disc structure.

An electric push rod is mounted on a rear side of the discharging device, a U-shaped discharging hopper is mounted at front of the electric push rod, and the U-shaped discharging hopper is mounted on a sliding plate.

A marking device employs a laser marking machine, and the marking machine employs an optical fiber laser and a galvanometer based marking head.

A personalized automatic customization method for a ring-pull can, comprising following steps of:
(1) setting a pattern of a marking content on a control system, and inputting the marking content on the control system;
(2) driving a feeding wheel by a feeding motor to rotate through a quarter turn per time, and providing one canned beverage per quarter turn;
(3) driving a pushing bar by a linear actuator in a pushing device, to push the ring-pull can to a positioning device;
(4) rotating the positioning device, to trigger positioning sensors to send a signal which indicates successful positioning;
(4) receiving a positioning signal by the control system, and driving a marking head to mark the marking content on an outer surface of the ring-pull can;
(5) driving the pushing bar by the linear actuator to move forward, so as to push the ring-pull can towards a second chute; and

(6) extending a push rod out of an electric cylinder by the electric push cylinder to push forward the discharging hopper, which receives the ring-pull can falling along the second chute.

The present disclosure has the following beneficial effects: the personalized customized automation apparatus and method for the ring-pull can of the present disclosure can automatically implement loading, positioning, making and discharging on the same one apparatus. The apparatus has a simple structure and is convenient to operate, so as to meet the individual needs of customization and realize automated operation. The laser marking machine has a high marking speed without the need of other consumables.

### BRIEF DESCRIPTION OF THE DRAWINGS

FIG. 1 is a schematic view of a structure of the present disclosure;

FIG. 2 is a schematic rear view of the structure of the present disclosure;

FIG. 3 is a schematic view of a bin device and a distributing device;

FIG. 4 is a schematic view of a pushing device and a positioning device;

FIG. 5 is a schematic view of a laser head; and

4FIG. 6 is a schematic view of a discharging device.

List of reference numerals: 1 bin device, 2 distributing device, 3 pushing device, 4 positioning device, 5 discharging device, 6 marking device, 7 bin door, 8 bin, 9 feeding wheel, 10 feeding motor, 11 first chute, 12 U-shaped groove, 13 pushing plate, 14 pushing motor, 15 sliding block, 16 screw rod, 17 second chute, 18 positioning roller, 19 roller motor, 20 laser head, 21 electric cylinder, 22 discharging hopper, 23 sliding plate.

### DETAILED DESCRIPTION OF THE EMBODIMENTS

The present disclosure will be further described below with reference to the accompanying drawings and embodiments.

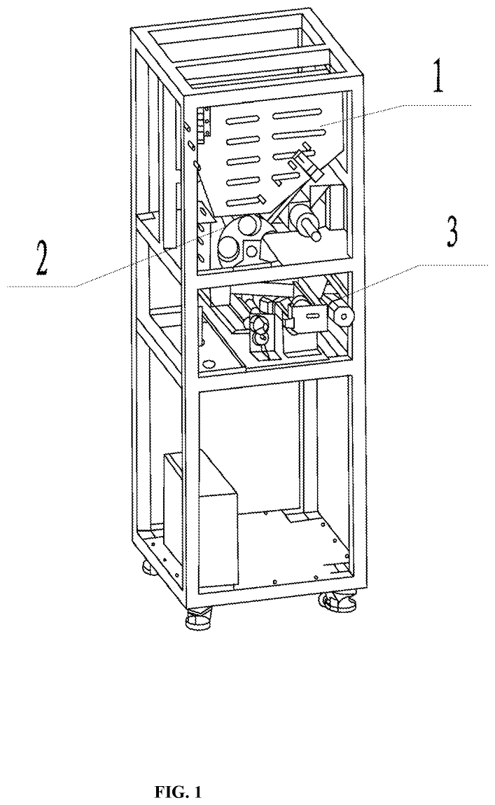

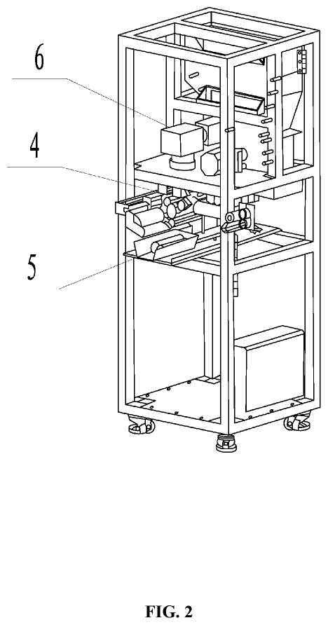

As shown in FIG. 1 and FIG. 2, the present disclosure provides a personalized automatic customization apparatus for a ring-pull can, which includes a bin device 1, a distributing device 2, a pushing device 3, a positioning device 4, a discharging device 5 and a marking device 6. The bin device 1 is located at an upper part of the apparatus, the distributing device 2 is installed below the bin device 1, and the pushing device 3 is arranged on a side of the distributing device 2 and the positioning device 4. Canned beverages are stored in the bin device 1, and the distributing device 2 rotates to cause the beverage to fall into a feeding groove, and continues to rotate to cause the canned beverage to fall into the pushing device 3 there below. The canned beverage is pushed by a pushing bar to move to the positioning device 4. Upon being successful positioned, the canned beverage is marked by the marking device 6, and after the marking is completed, the pushing device 3 pushes the canned beverage forward and causes the canned beverage to fall into the discharge device 5, which extends forward.

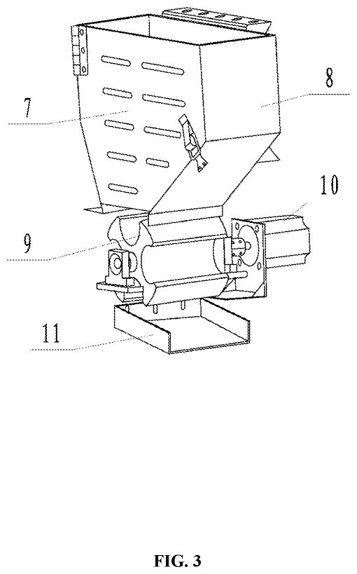

As shown in FIG. 3, the bin 8 is substantially V-shaped, and the bin door 7 can be opened to place a ring-pull can to be marked into the bin 8, and the bin door 7 is provided with a lock catch, by which the bin door 7 can be locked. The feeding motor 10 drives the feeding wheel 9 to rotate through a quarter turn per time. One canned beverage is provided per quarter turn and falls down along the first chute 11.

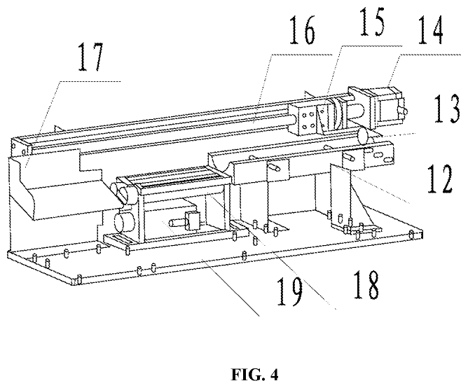

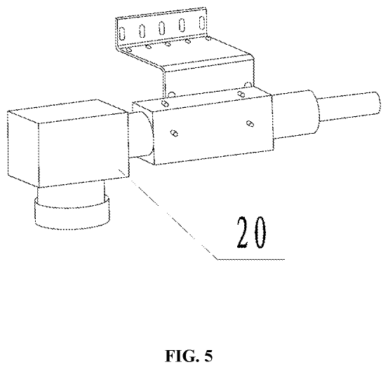

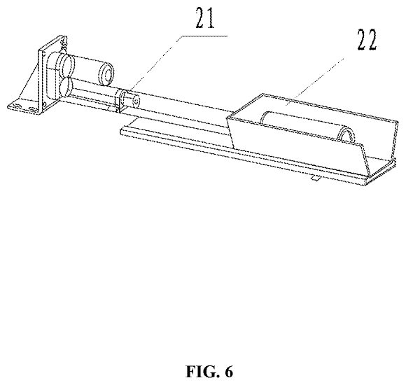

As shown in FIG. 4 and FIG. 5, the ring-pull can rolls into the U-shaped groove 12, the pushing motor 14 drives the screw rod 16 to rotate, and then the sliding block 15 drives the pushing plate 13 mounted thereon to move forward, so as to push the ring-pull can to an upper surface of positioning rollers 18. The roller motor 19 drive a belt which in turn drive the positioning rollers to rotate to implement the positioning. After the laser head 20 completes the marking, the pushing motor 14 again drives the screw rod 16 to rotate, and then the sliding block 15 drives the pushing plate 13 mounted thereon to go on moving forward to push the ring-pull can towards the second chute 17.

As shown in FIG. 6, the discharging hopper 22 is mounted on the sliding plate 23. The ring-pull can falls in the discharging hopper 22 along the second chute 17, and then the electric cylinder 21 causes the push rod to project from the electric cylinder 21 to push the discharging hopper 22 forward.

In summary, the personalized automatic customization apparatus for the canned beverage has a simple structure, is convenient in operation, and can be operated automatically, improving working efficiency.

What is claimed is:

1. A personalized automatic customization apparatus for a ring-pull can, comprising: a bin device, a distributing device, a pushing device, a positioning device, a discharging device and a control system, wherein the bin device is located at an upper part of the apparatus, the distributing device is installed below the bin device, and the pushing device is arranged on a side of the distributing device and the positioning device; and the bin device, the distributing device, the pushing device, the positioning device and the discharging device are respectively electrically connected to the control system, wherein,
in the bin device, a bin employs a V-shaped structure, an upper portion of the bin is free of lid, a lower portion of the bin is provided with an outfeed opening, a side door of the bin is able to be opened, and the side door is provided with an elongated hole;
the distributing device is mounted below the outfeed opening, and includes a feeding wheel which is machined with a nylon block, and the feeding wheel includes four semicircular feeding grooves arranged at equal intervals around an axial direction of the feeding wheel, and the feeding wheel is driven to rotate by a motor, and a first chute is mounted below the feeding wheel, and the first chute is connected to a U-shaped groove arranged below the first chute;
the pushing device comprises a linear actuator and a pushing bar, wherein the pushing bar can be driven by the linear actuator to push the ring-pull can to a marking position and a discharging position;
the positioning device employs a roller type rotation mechanism, and comprises two rollers, a motor is mounted below the rollers, the motor drives the rollers to rotate by means of a belt, and positioning sensors is mounted above a first side of each of the rollers;
the pushing device is located on a common side of the U-shaped groove and the positioning device, the pushing device is an electric linear actuator, the pushing bar is mounted on a sliding block of the linear actuator, and a tail end of the pushing bar is of a disc structure;
an electric push rod is mounted on a rear side of the discharging device, a U-shaped discharging hopper is mounted at front of the electric push rod, and the U-shaped discharging hopper is mounted on a sliding plate.

2. The personalized automatic customization apparatus for the ring-pull can according to claim 1, wherein the feeding wheel of the distributing device is machined with the nylon block.

3. The personalized automatic customization apparatus for the ring-pull can according to claim 1, wherein a marking device employs a laser marking machine, and the marking machine employs an optical fiber laser and a galvanometer based marking head.

4. A personalized automatic customization method for a ring-pull can, comprising steps of:
setting a pattern of a marking content on a control system, and inputting the marking content on the control system;
driving a feeding wheel by a feeding motor to rotate through a quarter turn per time, and providing one canned beverage per quarter turn;
driving a pushing bar by a linear actuator in a pushing device, to push the ring-pull can to a positioning device;
receiving a positioning signal by the control system, and driving a marking head to mark the marking content on an outer surface of the ring-pull can;
driving the pushing bar by the linear actuator to move forward, so as to push the ring-pull can towards a second chute; and
extending a push rod out of a electric cylinder by the electric push cylinder to push forward the discharging hopper, which receives the ring-pull can falling along the second chute.

5. The personalized automatic customization method for the ring-pull can according to claim 4, wherein the marking content is any one of words, numbers and letters.
